(19) United States
(12) Patent Application Publication
(10) Pub. No.: US 2011/0130242 A1
(43) Pub. Date: Jun. 2, 2011

(54) Multi-Speed Internal Gear Hub for a Bicycle

(75) Inventor: Joachim GÖBEL, Prosselsheim (DE)

(73) Assignee: SRAM Deutschland GmbH, Schweinfurt (DE)

(21) Appl. No.: 12/955,675

(22) Filed: Nov. 29, 2010

(30) Foreign Application Priority Data
Nov. 28, 2009 (DE) 102009056206.0

(51) Int. Cl. F16H 3/44; F16H 57/10

(52) U.S. Cl. 475/297; 475/296

(57) ABSTRACT

A bicycle multi-speed internal gear hub including a hub axle, a hub shell rotatably mounted about the hub axle, a driver rotatably mounted about the hub axle and at least two gear stages providing at least two gear ratios. Each gear stage includes a planetary gear mechanism having at least one sun gear, a sun gear clutch connecting the sun gear and the hub axle to rotate together, a planet carrier and a ring gear. The at least two gear stages connected in series. One of the at least two gear stages is an overdrive gear stage with a greater speed at a gear stage output then at a gear stage input, the other of the at least two gear stages is an underdrive gear stage with a lower speed at the gear stage output than at the gear stage input. One of the at least two gear stages is coupled to the driver and the other of the at least two gear stages is coupled to the hub shell. One of the at least two gear stages provides a plurality of smaller gear ratios, the other of the at least two gear stages provides a plurality of larger gear ratios. A direct drive gear stage with a gear ratio of 1:1 is not used in one of the at least two gear stages.

### BACKGROUND OF THE INVENTION

The present invention relates to multi-speed internal gear hubs for bicycles, and more particularly, to a bicycle multi-speed internal gear hub having at least two gear stages wherein one of the gear stages does not use the gear ratio of 1:1.

Internal gear hubs usually include a planetary gear mechanism generally including a sun gear, a plurality of planet gears rotatably mounted on a planet carrier and a ring gear. The internal gear hubs may provide as many as 14 speeds or gears. Each speed or gear corresponds to a selectable torque transmission path through the planetary gear mechanism. A couple of advantages of internal gear hubs over bicycle derailleurs are the easy maintenance due to the hub being located in the wheel hub shell and simple actuation. However, a drawback of internal gear hubs is the high manufacturing costs due to their complicated mechanical structures. Therefore, there is a need for an internal gear hub with a simplified design that lowers the manufacturing costs.

To achieve a large number of speeds, different gear components of the planetary gear mechanism are used as inputs and outputs. For example, the planet carrier may be the input by coupling it to the driver, which includes a sprocket, and the ring gear is the output by coupling it to the hub shell. This configuration represents an overdrive gear or speed. If the alternative is chosen with the ring gear as the input and the planet carrier as the output an underdrive gear or speed is obtained. A direct drive gear or gear ratio 1:1 is obtained by running the input to the output along the same co-rotating gear components or the gear is made inactive by blocking, in which case all gear components revolve together as a “block.” Both positive clutches and detents in freewheel clutches are considered as blocking means. Direct drive is generally used as an option. Use of these three torque transmission paths through a single planetary gear mechanism represents a three-speed hub.

Only about three to four speeds can be achieved in a pure overdrive planetary gear mechanism as described in EP 0 679 570. They require primary transmissions on the chain drive from the crank to the sprocket on the driver of the gear hub of 1:1 or even 1:1.2. At a higher speed, i.e., at a higher covered path per crank revolution, very high torques occur. They can only be taken up by highly loadable components in the gear hub, which can be implemented by larger design widths or more highly loadable materials. However, this again limits the number of speeds through the design width and/or increases the manufacturing costs.

Another method of achieving a large number of speeds includes using several sets of planet gears in a planet carrier. Adjacent planet gears are coupled to form planet gear stages. The set of planet gears of a planet gear stage need not engage simultaneously with the assigned sun gear and the assigned ring gear and mesh with each other. For example, a set of planet gears may engage the sun gear and the other set of planet gears may engage the ring gear. This configuration of sets of planet gears has two gear stages. Further, different planet gear sets of a two-stage planetary gear mechanism may also mesh with different ring gears separated from each other in the axial direction as described in U.S. Pat. No. 3,973,451.

Another method of achieving a large number of speeds includes using several planetary gear mechanisms in series or in more complex coupling structures. Direct coupling of different gear components of different planetary gear mechanisms may be used such as planet carrier with planet carrier as described in DE 41 42 867 or ring gear with ring gear and ring gear with planet carrier which is also described in DE 41 42 867. Further, the gear components of different planetary gear mechanisms may be shared such as the sun gear of one planetary gear mechanism functions as the ring gear or planet carrier of the axially adjacent planetary gear mechanism as described in DE 197 45 419.

### SUMMARY OF THE INVENTION

The present invention provides a bicycle multi-speed internal gear hub including a hub axle, a hub shell rotatably mounted about the hub axle, a driver rotatably mounted about the hub axle and at least two gear stages providing at least two gear ratios. Each gear stage includes a planetary gear mechanism having at least one sun gear, a sun gear clutch connecting the sun gear and the hub axle to rotate together, a planet carrier and a ring gear. The at least two gear stages connected in series. One of the at least two gear stages is an overdrive gear stage with a greater speed at a gear stage output then at a gear stage input, the other of the at least two gear stages is an underdrive gear stage with a lower speed at the gear stage output than at the gear stage input. One of the at least two gear stages is coupled to the driver and the other of the at least two gear stages is coupled to the hub shell. One of the at least two gear stages provides a plurality of lower gear ratios, the other of the at least two gear stages provides a plurality of higher gear ratios. A direct drive gear stage with a gear ratio of 1:1 is not used in one of the at least two gear stages.

The present invention may provide a large number of speeds or gears while providing better controllability during shifting. This is achieved by providing a larger number of planet gear sets, by shifting between speeds exclusively by fixing the sun gears on the hub axle with one-way clutches and by selecting specific number of teeth for the individual planet gear sets.

The present invention may provide a compact design in the axial direction by providing the sun gears with enough teeth such that the control elements for fixing the sun gears to the hub axle may be disposed on the same axial section on which the planetary gearing is also situated.

The present invention may provide at least two gear stages, one gear stage providing lower speeds and the other gear stage providing higher speeds. This is achieved by selecting the appropriate number of teeth for each of the gear components in the at least two gear stages. In one embodiment the direct drive gear stage with a gear ratio 1:1 is not used in the gear stage providing the lower speeds or gears.

In one embodiment of the present invention, the gear stage coupled to the driver is the underdrive stage and the planet carrier is coupled to the planet carrier of the other gear stage. In another embodiment of the present invention, the gear stage coupled to the driver is the overdrive gear stage and the ring gear is coupled to the ring gear of the other gear stage.

In one embodiment of the present invention, the plurality of planet gears of the at least two gear stages are mounted to a common planet carrier. The common planet carrier includes a planet gear axle for supporting the plurality of planet gears of the at least two gear stages. The plurality of planet gears of the at least two gear stages are connected to rotate together.

The present invention may provide a rotatory control of the coupling elements between the sun gears and the hub axle to reduce design space in the axial direction. The present invention only uses control elements that move in a rotatory fashion to control clutches in the radial direction. This provides a simple gear design, in which only engagement elements on the sun gears are controlled in the radial direction.

These and other features and advantages of the present invention will be more fully understood from the following description of one or more embodiments of the invention, taken together with the accompanying drawings.

### BRIEF DESCRIPTION OF THE DRAWINGS

In the drawings:

FIG. 1 is a schematic of an internal gear hub according to one embodiment of the present invention;

FIG. 2 is a cross-sectional view through a center axis of the internal gear hub;

FIG. 3 is a cross-sectional view perpendicular to the hub axle showing the sun gear, a corresponding sun clutch and a shift shell; and

FIG. 4 is a schematic of an internal gear hub according to another embodiment of the present invention.

### DETAILED DESCRIPTION

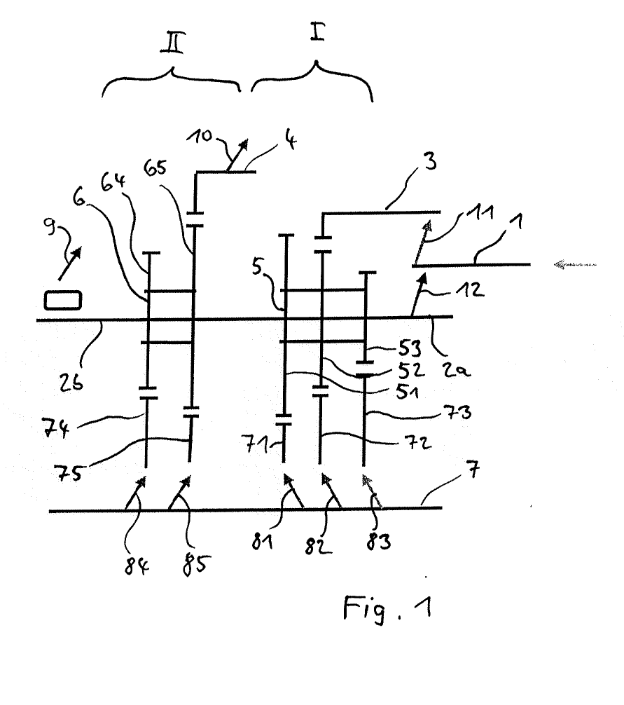

FIGS. 1-3 illustrate a bicycle multi-speed internal gear hub according to one embodiment of the present invention. The internal gear hub generally includes a hub axle 7, a hub shell rotatably mounted on the hub axle 7, a driver 1 rotatably mounted on the hub axle 7, and at least two gear stages I and II. The drive force is inputed on the driver 1, in which rotational entrainment occurs in the forward rotational movement through the driver freewheel clutch 11 to the input of the first gear stage I on the first ring gear 3. The planet carrier 2a, 2b carries the first stage planet gear set 5 and the second stage planet gear set 6. The first stage planet gear set 5 includes a first planet gear 51, a second planet gear 52 and a third planet gear 53, which are connected to rotate together. Additional planet gears spaced in the peripheral direction, which belong to a planet gear set, are disposed in the planet carrier 2a, 2b, all of which engage simultaneously with the same sun gear. First, second and third sun gears 71, 72 and 73 are assigned to the planet gears 51, 52 and 53. The sun gears may rotate together relative to the hub axle 7 by controllable sun gear clutches 81, 82, and 83 assigned to the sun gears. The sun gear clutches 81, 82, 83 are freewheel clutches. Since the first ring gear 3 is driven in the forward direction of rotation in the first gear stage I, the sun gear clutches 81, 82, 83 must support the sun gears relative to rotation in the backward direction of rotation.

The first gear stage I is an underdrive gear stage since the speed of the first ring gear is greater than the speed of the planet carrier 2a. The number of teeth of the first ring gear 3, the planet gears 51, 52, 53 and the sun gear 71, 72, 73 determine the gear ratio. The gear ratio of 1:1 is not used in the first gear stage I. Since the 1:1 gear ratio is not used, a gear stage must therefore always be active, at least one sun gear must be made to rotate with the hub axle 7 in all shift states, in this embodiment the largest sun gear 81. The clutch on the largest sun gear 73 need not be shifted. The sun gear clutch 83 acting as freewheel is automatically overrun, if a sun gear clutch 81, 82 of a smaller sun gear 71, 72 makes this sun gear 71, 72 rotate with the hub axle 7.

The second gear stage II is similar to the first gear stage I. The second gear stage II includes the planet carrier 2b, the second stage planet gear 6, the sun gear 74, 75 and the second internal gear 4. The second gear stage II is an overdrive gear stage since the output speed at the second ring gear 4 is greater than the input speed at the planet carrier 2b.

Shifting between gear ratios occurs through controllable sun gear clutches 84, 85 which are also designed as freewheels and make the corresponding sun gear 74, 75 rotate with the hub axle 7 with reference to a forward direction of rotation. Output occurs at the second ring gear 4 when one of the sun gears 74, 75 is made to rotate with the hub axle 7. If both sun gears 74, 75 are freely rotatable, the output occurs at the planet carrier 2b, which has a planet gear freewheel 9 relative to the hub shell.

The planet carrier 2a, 2b serves to transfer the backward rotational movement to a backpedal brake. Backpedal operation is also initiated on driver 1 like the forward drive rotational movement. A brake freewheel to be coupled backwards is arranged between driver 1 and the planet carrier 2a. In order for the first ring gear 3 running backward more quickly than the planet carrier during brake activation not block the gear mechanism, the driver freewheel clutch 11 must be switched off during backward rotation. If the gear hub is designed without the backpedal brake, the need to switch off the driver freewheel clutch 11 during backward rotation drops out. The driver 1 and the first ring gear 4 may be formed as an integral part.

In another embodiment, the brake freewheel entrains the planet carrier in the backward direction of rotation so that the backpedal brake is controlled. The backpedal brake may be designed as a reel brake, in which rollers move the brake shoes radially outward on ascending fields, or as a cone brake, in which an axially moved cone radially spreads the brake shoes. Brake operation occurs with direct transfer of the activation movement on the driver independently of the selected total gear ratio for forward rotation. FIG. 1 represents a 9-speed version of a backpedal brake. The nine speeds are obtained by multiplication of the three gear stage transmissions of the underdrive gear stage I with the three possible states of the overdrive gear stage II.

### The Three Shift States of the Gear Stage I are:

1. First sun gear 71 fixed;
2. Second sun gear 72 fixed;
3. Third sun gear 73 fixed.

### The Three Shift States of the Gear Stage II are:

1. Fourth sun gear 74 fixed
2. Fifth sun gear 75 fixed
3. Both sun gear 74 and sun gear 75 not fixed.

Depending on the number of teeth and the speeds resulting from this it is also possible to deliberately not utilize all possible states and derive a 7- or 8-speed hub from the 9-speed principle. If, for example, the gear stage I is reduced to two planet stages, a further simplification is obtained, but only a maximum of six possible speeds. If, for example, the gear stage II is expanded to three planet stages, a maximum of 12 possible speeds is obtained. Through the number of planet stages within the two gear stages I and II the number of maximum possible speeds is therefore obtained. Other speed layouts are also conceivable.

If one advantageously chooses the number of teeth in both gear stages I and II, the same pitch circle diameter of the planet carrier is obtained in both stages. Because of this a single planet carrier 2 is sufficient and two planet carriers need not be provided. Only a single cylinder pin is also usable for all axially adjacent planet gears of both gear stages I and II.

If possible, the number of teeth is chosen so that a cylinder pin with different running diameters and with shoulders need not be used. If all planet gears of a planet gear set engaged with a sun gear can engage at the same angle of rotation on the sun gear with reference to the teeth, no gauge is required for assembly of the gear stages. These specifications for simplification naturally always represent a compromise for the overall development and the speed jumps of the gear hub.

The layout of a 9-speed version is given below as an example, in which all planet stages can be mounted on a cylinder pin, a single planet carrier is sufficient and only the underdrive gear stage requires an assembly gauge. The speeds and overall development corresponding to current market requirements can be deduced from the following tables.

In the tables:

sun gear 71, planet gears 51 belong to underdrive 1;

sun gear 72, planet gears 52, internal gear 3 belong to underdrive 2;

sun gear 73, planet gears 53 belong to underdrive 3;

sun gear 74, planet gears 64, internal gear 4 belong to overdrive 1;

sun gear 75, planet gears 65 belong to overdrive 2.

Gear Ratios i and number of teeth

| | i | Sun gear | Planet gears | Internal gear |
|---|---|---|---|---|
| Underdrive 1 | 1.408 | 48 teeth | 21 teeth | |
| Underdrive 2 | 1.643 | 54 teeth | 15 teeth | 84 teeth |
| Underdrive 3 | 1.848 | 57 teeth | 12 teeth | |
| Overdrive 1 | 0.449 | 57 teeth | 12 teeth | |
| Overdrive 2 | 0.674 | 45 teeth | 24 teeth | 93 teeth |

| Speed | Coupling | i | i in % | delta i in % |
|---|---|---|---|---|
| 1 | UD3 | 1.848 | 54.1% | |
| | | | | 13% |
| 2 | UD2 | 1.643 | 60.9% | |
| | | | | 17% |
| 3 | UD1 | 1.408 | 71.0% | |
| | | | | 13% |
| 4 | UD3*OD2 | 1.246 | 80.3% | |
| | | | | 13% |
| 5 | UD2*OD2 | 1.107 | 90.3% | |
| | | | | 17% |
| 6 | UD1*OD2 | 0.949 | 105.4% | |
| | | | | 14% |
| 7 | UD3*OD1 | 0.830 | 120.4% | |
| | | | | 13% |
| 8 | UD2*OD1 | 0.738 | 135.5% | |
| | | | | 17% |
| 9 | UD1*OD1 | 0.633 | 158.1% | |
| | | | 292.1% | |

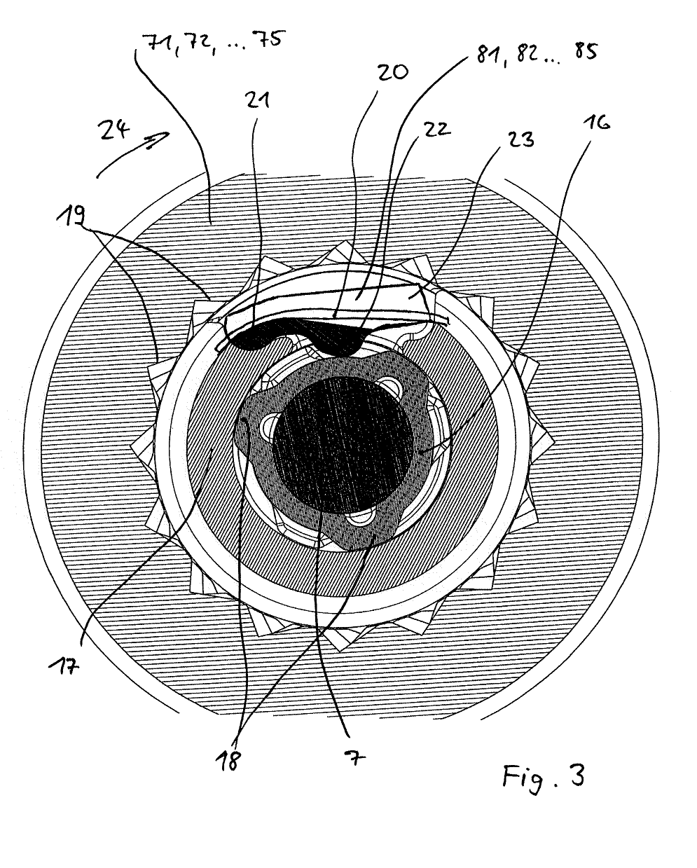

Looking to FIG. 3, a clutch carrier 17 is fastened nonrotationally on hub axle 7, which contains the sun gear clutches 81, 82, . . . 85 for fixing the sun gear 71, 72, . . . 75 and on whose outside diameter the sun gears run. A rotatable shift cam shell 16 between hub axle 7 and clutch carrier 17 then controls the sun gear clutches 81, 82, . . . 85 on or off. The sun gear clutches 81, 82, . . . 85 are made active by shift cams 18 under shift cam sleeve 16 in engagement with teeth of locking teeth 19 arranged radially inward on the sun gears. One clutch spring 20 is also provided for each sun gear clutch, which has a supporting effect of disengaging the sun gear clutch when the sun gear clutch is not held engaged by a shift cam. The sun gear clutch has two pivots. The sun gear clutch rotates about the support pivot 21 when a shift cam 18 is moved under the clutch lobe 22, causing the engagement end 23 of the sun gear clutch to engage the locking teeth 19. The sun gear clutch rotates around the clutch lobe 22, when a shift cam 18 is moved beneath clutch lobe 22, the sun gear clutch is pivoted and the engagement end 23 of the sun gear clutch is brought out of engagement with the locking teeth. These conditions are also present when the shift cam 18 is situated beneath the clutch lobe 22 and the sun gear is moved in the freewheel direction 24 relative to the sun gear clutch. The sun gear clutch then executes a rocking movement around the clutch lobe as pivot, in which, in alternation, one flank of the locking teeth moves the engagement end 23 or the opposite flank of the locking teeth 19 moves the support pivot 21, which temporarily is moving radially outward, radially inward. The spacings of the locking teeth 19 in the peripheral direction must be adapted to the spacing between the engagement end 23 and the support pivot 21 so that simultaneous entry of engagement end 23 and support pivot 21 into the tooth intermediate spacings on locking teeth 19 is temporarily possible.

The angle conditions on the engagement end 23 and in the locking teeth 19 relative to support pivot 21 are chosen so that only limited forces are transferred during engagement between engagement end 23 and locking teeth 19 on the clutch lobe. Because of this, uncoupling of the sun gear clutch is possible with limited forces, which means a limited necessary torque on the shift cam sleeve 16 and ultimately a limited operating force on the gear shift normally mounted on the handlebars. Since the shift cam sleeve 16 with its shift cams 18 can be rotated beneath the sun gear clutches even with the sun gear stopped, the possibility is obtained of shifting when the pedals are stopped and there is no drive movement and even when the bicycle is stopped.

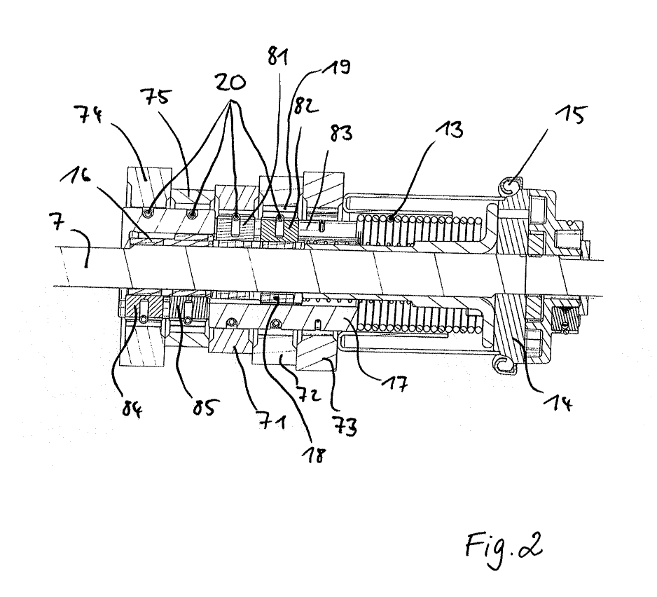

Looking to FIG. 2, the shift cam sleeve 16 is designed in two parts but only for assembly reasons. Both parts of the shift cam sleeve 16 rotate together. They extend over the entire axial length beneath sun gear 71, 72, . . . 75. The clutch carrier 17 also extends over the entire axial length beneath the sun gears. Shift cams 18 engage in the clutch carrier 17 through openings 26.

The recovery spring 13 rotates the shift cam sleeve back from the position in which it was brought by the action of a shift operating cable (not shown). For this purpose one end of the spring 13 is fixed relative to hub axle 7, the other end is hooked onto the shift cam shell 16. At the same time the recovery spring 13 forces the clutch carrier 17 on a stop (not shown) situated to the left into a defined position.

The gear hub according to the invention is favorable for manufacture and can be combined with a backpedal brake of known and proven design, in which operation of the backpedal brake occurs independently of the selected speed. The means for shifting with coupling to a pull cable can also be arranged between the fork ends where they do not protrude laterally from the bicycle and are protected from damage. By using sun gear clutches that also require only limited shifting forces under load, a speed change can also be made under load with limited shifting forces. By the number of planet stages within the two gear stages a wide variety of speeds can be implemented, reasonably 4 to 12 speeds.

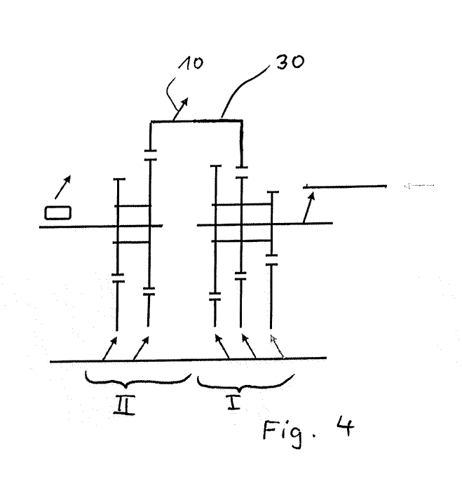

FIG. 4 shows an alternative embodiment of an internal gear hub in which the rings gears are coupled or a single ring gear engages both the planet gears of the first gear stage I and the second gear stage II. It is apparent that the internal gear freewheel 10 between ring gear 3 and the hub shell must also be designed controllable. Other requirements for operation of the backpedal brake are also apparent.

While this invention has been described by reference to one or more embodiments, it should be understood that numerous changes could be made within the spirit and scope of the inventive concepts described. Accordingly, it is intended that the invention not be limited to the one or more disclosed embodiments, but that it have the full scope permitted by the language of the following claims.

What is claimed:

1. A bicycle multi-speed internal gear hub comprising:
a hub axle;
a hub shell rotatably mounted about the hub axle;
a driver rotatably mounted about the hub axle;
at least two gear stages providing a plurality of gear ratios, each gear stage including a planetary gear mechanism including:
at least one sun gear,
a sun gear clutch connecting the sun gear and the hub axle to rotate together,
a planet carrier,
a plurality of planets rotatably mounted to the planet carrier, and
a ring gear,
the at least two gear stages connected in series,
one of the at least two gear stages being an overdrive gear stage with a greater speed at a gear stage output then at a gear stage input, the other of the at least two gear stages being an underdrive gear stage with a lower speed at the gear stage output than at the gear stage input,
one of the at least two gear stages coupled to the driver and the other of the at least two gear stages coupled to the hub shell,
one of the at least two gear stages providing a plurality of lower gear ratios, the other of the at least two gear stages providing a plurality of higher gear ratios,
a direct drive gear stage with a gear ratio of 1:1 not being used in one of the at least two gear stages.

2. The bicycle multi-speed internal gear hub of claim 1 wherein the direct drive gear stage is not used in the gear stage with the plurality of lower gear ratios.

3. The bicycle multi-speed internal gear hub of claim 2 wherein the gear stage with the plurality of lower gear ratios, in which the direct drive gear stage is not used, a difference between directly adjacent gear ratios, which are not equal to 1:1, is much smaller than the difference between the gear ratio of 1:1 and the gear stage adjacent in value to the gear ratio of 1:1.

4. The bicycle multi-speed internal gear hub of claim 3 wherein the gear stage coupled to the driver is the underdrive gear stage and the planet carrier of the gear stage couple to the driver is coupled to the planet carrier of the other gear stage.

5. The bicycle multi-speed internal gear hub of claim 3 wherein the gear stage coupled to the driver is the overdrive gear stage and the ring gear of the gear stage coupled to the driver is coupled to the ring gear of the other gear stage.

6. The bicycle multi-speed internal gear hub of claim 5 wherein the sun gear clutch only connects the at least one sun gear and the hub axle such that the sun gear is fixed to the hub axle to rotate with the hub axle.

7. The bicycle multi-speed internal gear hub of claim 6 wherein the plurality of planet gears of the at least two gear stages are mounted to a common planet carrier.

8. The bicycle multi-speed internal gear hub of claim 7 wherein the common planet carrier includes a planet gear axle supporting the plurality of planet gears of the at least two gear stages, the plurality of planet gears of the at least two gear stages being connected to rotate together.

9. The bicycle multi-speed internal gear hub of claim 8 wherein the at least one sun gear has a large number of teeth and a larger outer diameter, the sun gear clutch disposed in axial section of the sun gear.

10. The bicycle multi-speed internal gear hub of claim 9 wherein the sun gear clutch is supported in the peripheral direction relative to the hub axle and only displaces radially, a shift cam sleeve is rotatably disposed about the hub axle to control the sun gear clutch.

11. The bicycle multi-speed internal gear hub of claim 10 wherein sun gear clutch is pivoted radially outwardly about a support pivot by a shift cam on the shift cam sleeve, the sun gear clutch engageable with locking teeth of the sun gear disposed radially outwardly, sun gear clutch is pivoted about a clutch lobe and is overrun by the locking teeth of the sun gear during relative rotation of the locking teeth relative to the sun gear clutch in a freewheel direction.

12. The bicycle multi-speed internal gear hub of claim 11 further comprising a brake freewheel is disposed between the driver and the planet carrier of the underdrive gear stage.

13. The bicycle multi-speed internal gear hub of claim 12 wherein a number of planet gears of the underdrive gear stage is greater than or equal to a number of planet gears of the overdrive gear stage.

14. The bicycle multi-speed internal gear hub of claim 13 further comprising a clutch carrier supporting the sun gear clutch and rotating with the hub axle.

15. The bicycle multi-speed internal gear hub of claim 14 wherein the shift cam sleeve is radially disposed between the hub axle and the clutch carrier.

16. The bicycle multi-speed internal gear hub of claim 1 wherein the plurality of planet gears of the at least two gear stages are mounted to a common planet carrier.

17. The bicycle multi-speed internal gear hub of claim 16 wherein the common planet carrier includes a planet gear axle supporting the plurality of planet gears of the at least two gear stages, the plurality of planet gears of the at least two gear stages being connected to rotate together.

18. The bicycle multi-speed internal gear hub of claim 1 wherein the at least one sun gear has a large number of teeth and a larger outer diameter, the sun gear clutch disposed in axial section of the sun gear.

19. The bicycle multi-speed internal gear hub of claim 1 wherein the sun gear clutch is supported in the peripheral direction relative to the hub axle and only displaces radially, a shift cam sleeve is rotatably disposed about the hub axle to control the sun gear clutch.

20. The bicycle multi-speed internal gear hub of claim 19 wherein the shift cam sleeve is radially disposed between the hub axle and the clutch carrier.
